(19) United States
(12) Patent Application Publication
(10) Pub. No.: US 2006/0149019 A1
(43) Pub. Date: Jul. 6, 2006

(54) Aqueous coatings for food containers

(76) Inventors: Christian Wamprecht, Neuss (DE); Jan Mazanek, Koln (DE); Beate Baumbach, Burscheid (DE); Wolfram Kuttner, Bergisch Gladbach (DE); Dorota Greszta-Franz, Erkrath (DE)

Correspondence Address: BAYER MATERIAL SCIENCE LLC, 100 BAYER ROAD, PITTSBURGH, PA, 15205, US

(21) Appl. No.: 11/301,622

(22) Filed: Dec. 13, 2005

(30) Foreign Application Priority Data
Dec. 17, 2004 (DE) 102004060798.2

(51) Int. Cl. C08G 18/00

(52) U.S. Cl. 528/44

(57) ABSTRACT

The present invention relates to aqueous coating compositions containing A) at least one polyisocyanate which contains an average of at least two NCO groups per molecule and in which at least 85% of the NCO groups are blocked with a blocking agent selected from ε-caprolactam and/or a hydroxycarboxylic acid, and
B) at least one hydrophilic polyester polyol containing an average of at least two reactive hydroxyl groups per molecule, or a mixture of hydrophilic and non-hydrophilic polyester polyols, wherein component B) has an acid number of ≧15 mg KOH/g, a hydroxyl number of 20 to 300 mg KOH/g and a weight average molecular weight, M_{w}, of >1500 g/mol, wherein the equivalent ratio between the blocked isocyanate groups of component A) and the isocyanate-reactive groups of component B) is 0.5 to 5.0:1. The present invention also relates to a process for preparing these aqueous coating compositions, to coatings obtained from these aqueous coating compositions, particularly coatings for packaging and for the interior of cans.

### BACKGROUND OF THE INVENTION

1. Field of the Invention

The present invention relates to aqueous coating compositions and to internal coatings produced from them on metallic food containers and food packaging.

2. Description of Related Art

One-component polyurethane baking varnishes (1K PU baking varnishes), predominantly containing a blocked polyisocyanate crosslinker component and a polyol binder component and their use in coating compositions for automotive OEM finishing, general industrial coating, and coil coating is known. 1K PU baking varnishes are coating compositions which cure at elevated temperatures to form a polyurethane network. During the cure the hydroxyl groups of the polyol react with the (de)blocked NCO groups of the polyisocyanate. The reaction of NCO groups blocked with CH-acidic esters with polyols, in contrast, takes place by transesterification, in which no polyurethane network is produced; consequently, coating compositions based on these blocked polyisocyanates are not called 1K PU baking varnishes.

A disadvantage associated with the use of blocked polyisocyanates for producing polyurethane coatings is that, depending on the nature of the blocking agent and the baking conditions, a greater or lesser proportion of the blocking agent remains in free form in the coating. The residual blocking agent content depends on the particular blocking agent itself, on its reactivity and on the baking conditions.

During the production of coatings on metallic packaging, known as can coatings, metal sheets, made of tinplate or aluminium for example, are coated with a baking varnish and, after the varnish is cured, are processed to the desired articles.

Exacting requirements are imposed here on the coating, particularly when the application is the interior coating of food containers, such as drink cans. The coatings must be flexible enough to withstand deformation during production of the containers and during transport of the packaged goods without damage to the coating (as a result of cracking, for example). In addition, the metallic substrate must be reliably protected from the influence of corrosive media. The capacity to adhere to the metallic substrate must exist both during deformation and during subsequent sterilization, as is necessary in particular for containers which serve as packaging for foods and drinks. It is undesirable for constituents of the coating to pass into the packaged goods during production and storage of the latter, since this can lead to an impairment of the product's properties.

The use of coating compositions based on bisphenol A diglycidyl ether (BADGE) is known. It is also known that small amounts of this substance, which exhibits mutagenic activity in in vitro tests, can pass into the packaged foods. Therefore, an objective is to use BADGE-free coatings for the interior coating of cans with food contact.

The use of polyurethane powder coating compositions based on polyisocyanates and polyols for producing interior coatings on packaging containers is described in DE-A 195 45 424. It is not known to use polyurethane coating compositions based on blocked polyisocyanates for coating the predominant part of the food containers with long-term contact with the food. The reason for this is that it is known that such coatings include a residual amount of free blocking agent. The inevitable assumption is that these chemicals would cross over into the contents and could lead to altered taste or clouding or, in the worst case, to damage to the health of the consumer.

Accordingly consideration has never been given to using coating compositions based on blocked polyisocyanates, which give off the blocking agent during crosslinking, for coating surfaces that are in direct contact with foods, since a potential toxicological risk could be assumed from the blocking agents given off. In particular there have been no attempts to date to use aqueous coating compositions based on polyurethane for this purpose.

An object of the present invention is to provide aqueous coating compositions for the internal coating of—preferably metallic—food packaging with long-term food contact, without the preceding disadvantages.

This object has been achieved with the self-crosslinking one-component baking compositions of the present invention. Surprisingly the coatings prepared from the coating compositions of the invention either contain no relative amounts of free blocking agents or these free blocking agents do not migrate into the packaged foods. In any case, no relevant amounts of the coating compositions are found in these foods, even when the interior surface of the container is fully covered with the coating compositions, as is the case, for example, with drink cans.

### SUMMARY OF THE INVENTION

The present invention relates to aqueous coating compositions containing
A) at least one polyisocyanate which contains an average of at least two NCO groups per molecule and in which at least 85% of the NCO groups are blocked with a blocking agent selected from ε-caprolactam, p-hydroxycarboxylic acid and aliphatic alcohol having a molecular weight <100 and
B) at least one hydrophilic polyester polyol containing an average of at least two reactive hydroxyl groups per molecule, or a mixture of hydrophilic and non-hydrophilic polyester polyols, wherein component B) has an acid number of ≧15 mg KOH/g, a hydroxyl number of 20 to 300 mg KOH/g and a weight average molecular weight, M_{w}, of >1500 g/mol,
   wherein the equivalent ratio between the blocked isocyanate groups of component A) and the isocyanate-reactive groups of component B) is 0.5 to 5.0:1.

The present invention also relates to a process for preparing the aqueous coating compositions of the invention by mixing components A) and B) below the temperature at which the blocked NCO groups of component A) can react with component B) and subsequently adding water and dispersing.

The present invention also relates to coatings obtained from the aqueous coating compositions of the invention.

The present invention also relates to the use of the aqueous coating compositions of the invention for coating packaging and for coating the interior of cans, and to metallic substrates coated with the coating compositions of the invention.

### DETAILED DESCRIPTION OF THE INVENTION

In the aqueous coating compositions the equivalent ratio between the blocked isocyanate groups of component A) and the isocyanate-reactive groups of component B) is 0.5 to 5.0:1, preferably 0.6 to 2.0:1 and more preferably 0.8 to 1.5:1.

Suitable polyisocyanates A) include polyisocyanates which have a low monomer content, are prepared from aliphatic, cycloaliphatic, araliphatic and/or aromatic diisocyanates and contain uretdione, isocyanurate, urethane, allophanate, biuret, iminooxadiazinedione and/or oxadiazinetrione groups.

Preferred diisocyanates are those containing aliphatically and/or cycloaliphatically attached isocyanate groups, such as 1,4-diisocynanatobutane, 1,6-diisocyanato-hexane (HDI), isophorone diisocyanate (IPDI), 4,4′-diisocyanatodicyclohexyl-methane and 1,3- and 1,4-bis(2-isocyanatoprop-2-yl)benzene.

Preferred are polyisocyanates and/or polyisocyanate mixtures containing isocyanurate, iminooxadiazinedione and/or biuret groups and prepared from HDI, IPDI and/or 4,4′-diisocyanatodicyclohexylmethane or mixtures of these compounds. Especially preferred are polyisocyanates prepared from IPDI and containing isocyanurate groups, since they are approved for use in packaging materials for food in accordance with European Standard EEC 2002/72. It is also possible to use any of the preceding polyisocyanates as mixtures with one other or with other crosslinkers, such as melamine resins, to prepare the coating compositions of the invention.

Suitable blocking agents for preparing component A) are p-hydroxybenzoic esters, ε-caprolactam and aliphatic alcohols having a molecular weight <100 or mixtures of these compounds. Preferred are ε-caprolactam and/or p-hydroxybenzoic esters.

The blocked polyisocyanates used in the coating compositions of the invention can be obtained by reacting polyisocyanates with ε-caprolactam and/or aliphatic alcohols having a molecular weight <100 and/or hydroxycarboxylic acids and/or derivatives thereof, preferably those of formula (I) 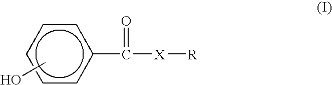
wherein
x is oxygen, NH or NR and
R is hydrogen, a C₁ to C₈ alkyl radical or a cycloalkyl radical.

Examples of the hydroxybenzoic acids or derivatives thereof include o-, m- and p-hydroxybenzoic acid and their methyl, ethyl, (iso)propyl, butyl, 2-ethylhexyl and tert-butyl-neopentyl esters; and amides such as methyl- and ethylamide and dimethyl- and diethylamide. Preferred hydroxycarboxylic acid derivatives are methyl, ethyl and butyl esters, especially the propyl esters of o- and/or p-hydroxybenzoic acid.

Preferred polyisocyanates A) contain
i) 100 equivalent % of polyisocyanate,
ii) 60-100 equivalent % of hydroxybenzoic acid derivatives of formula (I) and/or ε-caprolactam,
iii) 0-40 equivalent % of an at least difunctional compound containing hydroxyl and/or amino groups and having a number average molecular weight of 32 to 3000, preferably 32 to 1500, and
iv) optionally additives,
   wherein the amounts of the reactants are chosen such that the equivalent ratio of NCO groups of the polyisocyanate to isocyanate-reactive groups of components ii) and iii) is 1:0.8 to 1:1.2.

Suitable difunctional chain extender components iii) include diamines, diols and hydroxyamines having a number average molecular weight of 32 to 300. Preferred are C₂-C₁₂ diols and triols and also all isomers and mixtures of the following compounds: ethanediols, propanediols, butanediols, pentanediols, hexanediols, heptanediols, octanediols, nonanediols, decanediols and trimethylol ethane and propane. Other examples include hydrazine, ethylenediamine, isophoronediamine, the bisketimine of isophoronediamine and methyl isobutyl ketone, 1,4-dihydroxybutane, ethanolamine, N-methylethanolamine, hydroxyethylethylene diamine, and the adduct of 2 moles of propylene carbonate and 1 mole of hydrazine, which corresponds to formula (II)

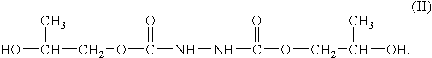

As film-forming binder B) use is made of at least one hydrophilic polyester polyol containing an average of at least two reactive hydroxyl groups per molecule, or mixtures of hydrophilic and non-hydrophilic polyester polyols. In addition to the polyester polyols of the invention, it is also possible to use other polyhydroxyl compounds, which should be present in an amount of not more than 50 mole %, based on the moles of component B). These other polyols are the known organic polyhydroxyl compounds from polyurethane coating technology and include polyester polyols, polyacrylate polyols, polyurethane polyols, polycarbonate polyols, polyether polyols, polyester-polyacrylate polyols, polyurethane-polyacrylate polyols, polyurethane-polyester polyols, polyurethane-polyether polyols, polyurethane-polycarbonate polyols, polyester-polycarbonate polyols, phenol/formaldehyde resins, and mixtures thereof.

The compounds used as film-forming binders B) contain an average of at least two NCO-reactive hydroxyl groups per molecule and are dilutable with water or dispersible or soluble in water. Polyhydroxyl compounds B) used are those having a weight average molecular weight, Mw of 1500 to 60,000, an OH content according to DIN 53 240/2 of 0.5% to 30% and an acid number of ≧15 mg KOH/g.

Preferred for use as polyhydroxyl compounds B) are polyols prepared from toxicologically unobjectionable constituents. Particular preference is given to those which are compliant with § 175300, USA Code of Federal Regulations 21, FDA and contain not more than 30% by weight of organic solvents. In combination with the polyisocyanate crosslinkers A) these polyhydroxyl compounds B) produce coatings having a very good level of properties, such as high elasticity, a high level of resistance to solvents, chemicals, and greasy and oily substances, and at the same time a high resistance under thermal stress.

FDA-compliant in this context means that in the binder compositions or for preparing them the components used are exclusively components listed according to § 175300 in USA Code of Federal Regulations 21 (FDA).

Particularly preferred polyols B) contain one or more water-dilutable polyester polyols and are prepared by reacting
a) 40 to 49 mole %, preferably 45 to 49 mole %, of a carboxylic acid component containing
   a1) one or more aliphatic, cycloaliphatic, araliphatic and/or aromatic carboxylic acids with a COOH functionality ≧2, preferably 2 to 3, or anhydrides thereof and
   a2) optionally aromatic, cycloaliphatic and/or aliphatic monocarboxylic acids with
b) 51 to 60 mole %, preferably 51 to 55 mole %, of an alcohol component containing
   b1) one or more aliphatic, cycloaliphatic and/or araliphatic polyols having a number average molecular weight of 62 to 272 g/mol and an average OH functionality ≧2, preferably 2 to 4, and
   b2) optionally aliphatic, cycloaliphatic and/or araliphatic monoalcohols and
c) optionally water,
d) optionally neutralizing agents, and
e) optionally solvents and additives.

Preferred aromatic di- or polycarboxylic acids and/or anhydrides a1) are phthalic acid, isophthalic acid, terephthalic acid, trimellitic acid, phthalic anhydride, trimellitic anhydride and/or pyromellitic anhydride; more preferably phthalic anhydride, terephthalic acid and/or isophthalic acid; and most preferably phthalic anhydride and/or terephthalic acid.

Preferred aliphatic di- or polycarboxylic acids a1) are succinic acid, maleic acid, adipic acid, sebacic acid, dodecanedioic acid, dimerized fatty acids, succinic anhydride and/or maleic anhydride; more preferably succinic anhydride, maleic anhydride and/or adipic acid; and most preferably adipic acid and/or maleic anhydride.

Preferred cycloaliphatic di- or polycarboxylic acids a1) are 1,4-cyclohexanedicarboxylic acid, hexahydrophthalic acid and/or hexahydrophthalic anhydride; more preferably 1,4-cyclohexanedicarboxylic acid and/or hexahydrophthalic anhydride; and most preferably 1,4-cyclohexanedicarboxylic acid.

Preferred monocarboxylic acids a2) are acetic acid, propionic acid, 1-octanoic acid, 1-decanoic acid, 1-dodecanoic acid, 1-octadecanoic acid, saturated and unsaturated fatty acids and/or benzoic acid; more preferably 1-dodecanoic acid, 1-octadecanoic acid, saturated and unsaturated fatty acids and/or benzoic acid; and most preferably saturated and unsaturated fatty acids and/or benzoic acid.

Preferred aliphatic polyols b1) are ethylene glycol, diethylene glycol, triethylene glycol, 1,2-propanediol, 1,4-butanediol, neopentyl glycol, 1,6-hexanediol, glycerol, trimethylolpropane, pentaerythritol and/or sorbitol; more preferably neopentyl glycol, ethylene glycol, diethylene glycol, 1,2-propanediol, 1,6-hexanediol, glycerol and/or trimethylolpropane; and most preferably neopentyl glycol, ethylene glycol, diethylene glycol, 1,2-propanediol and/or trimethylolpropane.

Preferred monoalcohols b2) are methanol, ethanol, 1-propanol, 1-butanol, 2-butanol, isobutanol, 1-pentanol, 1-hexanol, 2-ethylhexanol, 1-octanol, 1-decanol, 1-dodecanol, butyl glycol, and/or butyl diglycol; more preferably 2-ethylhexanol, 1-decanol, 1-dodecanol, cyclohexanol, butyl glycol and/or butyl diglycol; and most preferably 2-ethylhexanol, cyclohexanol, butyl glycol and/or butyl diglycol.

The compounds of components a1), a2), b1) and b2) can each be used individually or in any desired mixtures with one another in the respective components for preparing polyester polyols B). Preferred are compounds of components a1) and b1). Especially preferred for preparing polyester polyols B) are adipic acid, maleic anhydride, phthalic anhydride, isophthalic acid and terephthalic acid as component a1); and ethylene glycol, diethylene glycol, 1,2-propanediol, dipropylene glycol, neopentyl glycol and trimethylolpropane as component b1).

The polyester polyols B) are prepared in known manner as described in detail, for example, in “Ullmanns Encyclopädie der Technischen Chemie”, Verlag Chemie Weinheim, 4th edition (1980) volume 19, pages 61 ff. or by H. Wagner and H. F. Sarx in “Lackkunstharze”, Carl Hanser Verlag, Munich (1971), pages 86 to 152. The preparation is carried out preferably in the melt, optionally in the presence of a catalytic amount of a known esterification catalyst (such as acids, bases or transition metal compounds, e.g., titanium tetrabutoxide, dibutyltin oxide or butylstannic acid), at temperatures of 80 to 270° C., preferably of 100 to 250° C., under a nitrogen atmosphere. The stream of nitrogen also serves to remove the water of reaction that forms. Alternatively, the water of reaction can be removed by applying a vacuum of preferably up to 0.1 mbar. Optionally, it is also possible to add an azeotrope former, such as xylene, to expel the water of reaction. The esterification reaction is continued until the target values for the hydroxyl number and acid number and also for the viscosity have been reached. In one preferred embodiment of the invention an OH-functional polyester polyol is initially prepared, which contains small amounts of, or is free from, free carboxylic acid and/or carboxylate functions, and this polyol is then reacted, in a subsequent step, with a cyclic dicarboxylic anhydride, such as phthalic anhydride. A reaction accompanied by ring opening and monoester formation takes place with the desired number of free carboxylic acid and/or carboxylate groups being formed.

The weight average molecular weights, M_{w}, of the water-dilutable polyester polyols B) are >1500 g/mol, preferably >2000 g/mol, more preferably >3000 g/mol and most preferably between 5000 and 60,000 g/mol.

The OH numbers of water-dilutable polyester polyols B) are 20 to 300 mg KOH/g, preferably 25 to 250 mg KOH/g and more preferably from 30 to 200 mg KOH/g and most preferably from 35 to 150 mg KOH/g, based on resin solids. The acid numbers of water-dilutable polyester polyols B) are ≧15 mg KOH/g, preferably 20 to 75 mg KOH/g, more preferably 25 to 70 mg KOH/g and most preferably 30 to 60 mg KOH/g, based on resin solids.

Suitable neutralizing agents d) for neutralizing the carboxylic acid groups of the polyester polyols B) are both organic and inorganic bases. Preferred are primary, secondary and tertiary amines and ammonia, more preferably tertiary amines. Examples include triethylamine, tributylamine, N-methyldiethanolamme, N,N-dimethylethanolamine, N,N-diethylethanolamine, triethanolamine, triisopropylamine and triisopropanolamine. Especially preferred are N,N-dimethylethanolamine, triethanolamine and triethylamine.

Examples of components e) include solvents and additives, such as defoamers, thickeners, flow control agents, pigments, fillers, emulsifiers, dispersing assistants and light stabilizers.

As a general rule the desired processing viscosity is set by the addition of organic solvents or water, preferably water. In order to set very specific processing viscosities or to obtain particular rheological properties it is also possible to use thickeners or combinations of different thickeners, e.g. ionic and associative thickeners.

In order to make polyesters B) dilutable in water, the carboxylic acid groups present must be completely or partly neutralized with a neutralizing agent. The neutralizing agent d) can be added before, during or after the transfer of the polyester of the invention to the aqueous phase, preferably neutralization is carried out prior to transfer to the aqueous phase. The amount of component d) normally used for this purpose is 0.4 to 1.5 moles, preferably 0.5 to 1.4 moles and more preferably 0.6 to 1.3 moles, based on all of the COOH functions present in B).

To transfer the polyester polyols B) to the aqueous phase either they are introduced into the dispersing water c), optionally under strong shearing, such as vigorous stirring, or the dispersing water c) is stirred into the polyester polyol or polyols. It is often advantageous to add water-dilutable organic solvents e) to the polyester polyol prior to the dispersing operation. These solvents serve as auxiliary solvents or cosolvents. Examples of such solvents are butyl glycol or butyl diglycol.

The process for preparing the aqueous coating compositions of the invention is carried out by mixing components A), B) and optionally C) and subsequently adding water and dispersing. The mixing of components A) to C) is carried out below the temperature at which the blocked NCO groups can react with the other components. Mixing takes place preferably at temperatures of 15 to 100° C., more preferably 20 to 80° C.

In one embodiment of the process of the invention component A), which has not been rendered hydrophilic or has been rendered hydrophilic only to a small extent, is mixed prior to the addition of water, with component B) and subsequently both components are dispersed together. Component A), which has been rendered hydrophilic to a small extent, is a compound in which the amount of hydrophilic groups is so low that it is not sufficient for the formation of a sedimentation-stable dispersion. This low hydrophilicity component A) would either not be dispersible in water or else any dispersion formed would not be stable and a sediment would form.

Additives C) that can optionally be used include plasticizers, flow assistants, pigments, fillers, solvents or catalysts which accelerate the crosslinking reaction. Suitable catalysts are the known compounds from polyurethane chemistry which accelerate the reaction of isocyanate groups with hydroxyl groups. Examples include tin compounds, zinc compounds, zirconium compounds, bismuth compounds and titanium compounds. When catalysts are used, non-toxic catalysts are preferred, such as butyltin tris(2-ethylhexanoate), dibutytin bis(2-ethyl-hexanoate), tetrabutyl titanate and tin(II)(2-ethylhexanoate).

It is possible to use additional crosslinker components, such as amino resins. Suitable amino resins are the condensation products of melamine and formaldehyde or urea and formaldehyde that are known from coatings technology. Examples are the known melamine-formaldehyde condensates, which may be unetherified or etherified with saturated monoaclohols having 1 to 4 carbon atoms. When other crosslinker components are used, the amount of binder containing NCO-reactive hydroxyl groups or the amount of constituents containing NCO groups must be modified accordingly.

Each of components A) to C) can be used in solution in an organic solvent. Solvents may also be added following the mixing of components A) to C) to lower the viscosity. Suitable solvents include water or known coating solvents such as, ethyl acetate, butyl acetate, 1-methoxy-2-propyl acetate, 3-methoxy-n-butyl acetate, acetone, 2-butanone, 4-methyl-2-pentanone, cyclohexanone, toluene, xylene, N-methylpyrrolidone, chlorobenzene, ethylene and propylene glycol monomethyl ether, butyl glycol and butyl diglycol. Mixtures containing predominantly aromatics with a higher degree of substitution, which are available under the names Solvent Naphtha, Solvesso® (Exxon Chemicals, Houston, USA), Cypar® (Shell Chemicals, Eschborn, Del.), Cyclosol® (Shell Chemicals, Eschborn, Del.), Tolusol® (Shell Chemicals, Eschborn, Del.), Shellsol® (Shell Chemicals, Eschbom, Del.), are also suitable.

The coating compositions of the invention may be used for coating packaging and for coating the interior of cans. Preferred are cans used for packaging foodstuffs. The coating compositions are applied to an optionally precoated metallic substrate and are cured under elevated temperatures. It is also possible to use them to produce other coating compositions and adhesives.

The coating compositions are applied either directly to the metallic substrate or to coating films that have previously been applied to the substrate in known manner, for example, by spraying, dipping, flooding or by means of rolls or knife coaters.

The amount of coating composition applied is such that evaporation of any solvent present and the curing of the coating result in a dry film thickness for the interior coating of 1 to 50 μm, preferably 3 to 30 μm, more preferably 5 to 15 μm and most preferably 8 to 12 μm.

To form the coatings the substrates, following application of the coating compositions, are heated to temperatures of 100° C. to 400° C., preferably 180° C. to 260° C. and more preferably 190° C. to 240° C., and stored at this temperature for 1 second to 100 minutes, preferably 15 seconds to 30 minutes and more preferably 20 seconds to 15 minutes. Heating may take place discontinuously in baking ovens or continuously in coil-coating lines.

The coating compositions of the invention are suitable for coating packaging, and particularly for coating the interior of cans. They can also be used for coating the exterior of cans. The packaging may be composed of any of a very wide variety of materials and may have a wide variety of shapes. Preferred materials include black plate, tinplate and various iron alloys, which where appropriate have been provided with a passivating coat based on nickel compounds, chromium compounds and zinc compounds. The packaging can be coated in the form of can halves, i.e., bodies and lids, as 3-piece cans and as 2-piece, drawn and wall-ironed or otherwise deep-drawn cans, such as beverage cans and preserve cans.

Foods and other luxury goods are understood in the sense of the present invention to be foodstuffs in the widest sense or animal feedstuffs. These are liquid or solid products, and also semi-solid products, which contain water, fats, alcohol and/or protein. Examples include coffee, tea or extracts of coffee and tea, fruit drinks and/or carbonated drinks such as fruit and vegetable juices, wine, fizzy drinks, beer, champagne and sparkling wine and mixtures of these drinks. Also suitable are fish, meat, vegetable or fruit preserves, which optionally are cooked or frozen in the coated containers.

The coatings obtained from the coating compositions of the invention possess very good metal adhesion, absence of pores, resistance to container contents, high hardness and particularly good elasticity, which are generally considered to be contradictory properties. Additionally the coatings possess very high stability with respect to solvents, chemicals and water and exhibit good sterilization and pasteurization resistance and also taste neutrality, effective flow, and a high gloss. They are free from “BADGE” and have very high suitability as a coating for cans with food contact.

### EXAMPLES

In the following examples all percentages are by weight.

Properties determined were the solids content (thick-film method: lid, 1 g of sample, 1 h at 125° C., convection oven, basis: DIN EN ISO 3251); the acid number (mg KOH/g sample, titration with 0.1 mol/l NaOH solution, basis: DIN 53402); the viscosity (rotational viscometer VT 550 from Haake GmbH, Karlsruhe, DE, MV-DIN cup for viscosity <10 000 mPas/23° C.); the OH number (mg KOH/g sample, acetylation, hydrolysis, titration with 0.1 mol/l NaOH, basis: DIN 53240); and the Hazen color number (Hazen color number according to DIN 53995, Lico® 400 calorimeter, Dr Lange GmbH, Berlin, Del.). The acid number and OH number are reported both for the as-supplied form (asf) and for the solid resin (SR). The OH content can be calculated from the OH number by dividing by 33.

Abbreviations Used:

MPA: 1-methoxy-2-propyl acetate

DABCO: 1,4-diazabicyclo[2.2.2]octane

### Example 1

### Preparation of Water-Dilutable Polyester Polyol B1)

1646 g of diethylene glycol and 594 g of trimethylolpropane were weighed out together into a 5-liter reactor equipped with stirrer, heating, automatic temperature control, nitrogen inlet, column, water separator and receiver, and were heated to 120° C. with stirring and with nitrogen being passed through. Then 1298 g of terephthalic acid and 1415 g of phthalic anhydride were added and the mixture was heated to 230° C. at a rate such that the column overhead temperature did not exceed 103° C. During this heating operation the water of reaction was separated off. Condensation was carried out to a resin viscosity of 50 to 55 seconds (efflux time from a DIN 4 mm cup at 23° C., as a 55% solution in methoxypropyl acetate). The batch was then cooled to 140° C. Up to this point in time in the reaction, 536 g of resin were taken for samples. 536 g of phthalic anhydride were added to the remaining contents of the reactor and the mixture was stirred at 140° C. until a resin viscosity was reached of 87 to 92 seconds (efflux time from a DIN 4 mm cup at 23° C., 55% solution in methoxypropyl acetate). The resulting product was a clear resin, light in color, with an acid number of 47 mg KOH/g, an OH number of 71 mg KOH/g (based on resin solids) and a Hazen color number of 64 APHA (50% strength solution in methoxypropyl acetate).

### Example 2

### Preparation of Water-Dilutable Polyester Polyol B2)

4418 g of diethylene glycol and 1596 g of trimethylolpropane were weighed out together into a 15-liter reactor equipped with stirrer, heating, automatic temperature control, nitrogen inlet, column, water separator and receiver, and were heated to 120° C. with stirring and with nitrogen being passed through. Then 682 g of adipic acid, 2717 g of terephthalic acid and 3806 g of phthalic anhydride were added and the mixture was heated to 230° C. at a rate such that the column overhead temperature did not exceed 103° C. During this heating operation the water of reaction was separated off. Condensation was carried out to a resin viscosity of 86 to 91 seconds (efflux time from a DIN 4 mm cup at 23° C., as a 55% solution in methoxypropyl acetate). The batch was then cooled to 140° C. Up to this point in time in the reaction, 1428 g of resin were taken for samples. 1428 g of phthalic anhydride were added to the remaining contents of the reactor and the mixture was stirred at 140° C. until a resin viscosity was reached of 88 to 92 seconds (efflux time from a DIN 4 mm cup at 23° C., 50% solution in methoxypropyl acetate). The resulting product was a clear resin, light in color, with an acid number of 46 mg KOH/g, an OH number of 45 mg KOH/g (based on resin solids), a viscosity of 91 seconds (efflux time from a DIN 4 mm cup at 23° C., 50% solution in methoxypropyl acetate) and a Hazen color number of 64 APHA (70% strength solution in butyl glycol).

### Example 3

### Preparation of Water-Dilutable Polyester Polyol B3)

4375 g of diethylene glycol and 1579 g of trimethylolpropane were weighed out together into a 15-liter reactor equipped with stirrer, heating, automatic temperature control, nitrogen inlet, column, water separator and receiver, and were heated to 120° C. with stirring and with nitrogen being passed through. Then 689 g of adipic acid, 2743 g of terephthalic acid and 3845 g of phthalic anhydride were added and the mixture was heated to 230° C. at a rate such that the column overhead temperature did not exceed 103° C. During this heating operation the water of reaction was separated off. Condensation was carried out to a resin viscosity of 100 to 110 seconds (efflux time from a DIN 4 mm cup at 23° C., as a 50% solution in methoxypropyl acetate). The batch was then cooled to 140° C. Up to this point in time in the reaction, 1428 g of resin were taken for samples. 1428 g of phthalic anhydride were added to the remaining contents of the reactor and the mixture was stirred at 140° C. until a resin viscosity was reached of 75 to 85 seconds (efflux time from a DIN 4 mm cup at 23° C., 40% solution in methoxypropyl acetate). The resulting product was a clear resin, light in color, with an acid number of 55 mg KOH/g, an OH number of 40 mg KOH/g (based on resin solids), a viscosity of 85 seconds (efflux time from a DIN 4 mm cup at 23° C., 40% solution in methoxypropyl acetate) and a Hazen color number of 44 APHA (70% strength solution in butyl glycol).

### Example 4

### Preparation of a Water-Dilutable Polyester Polyol B4)

263 g of propane-1,2-diol, 4923 g of neopentyl glycol, 1233 g of trimethylolpropane and 3122 g of maleic anhydride were weighed out together into a 15-liter reactor equipped with stirrer, heating, automatic temperature control, nitrogen inlet, column, water separator and receiver, and were heated to 125° C. with stirring and with nitrogen being passed through. Then 2696 g of adipic acid were added and the mixture was heated to 180° C. at a rate such that the column overhead temperature did not exceed 103° C. During this heating operation the water of reaction was separated off. Condensation was carried out to an acid number of between 4 to 6 mg KOH/g. The batch was then cooled to 140° C. Up to this point in time in the reaction, 1160 g of resin were taken for samples. 1160 g of phthalic anhydride were added to the remaining contents of the reactor and the mixture was stirred at 140° C. until a resin viscosity was reached of 77 to 81 seconds (efflux time from a DIN 4 mm cup at 23° C., 60% solution in methoxypropyl acetate). The resulting product was a clear resin, light in color, with an acid number of 44 mg KOH/g, an OH number of 88 mg KOH/g (based on resin solids), and a viscosity of 79 seconds (efflux time from a DIN 4 mm cup at 23° C., 60% solution in methoxypropyl acetate). 2200 g of butyl glycol were added at 120° C. to 8800 g of this resin and then the batch was stirred at 120° C. for 2 hours. It was then cooled to 60° C. and the resin solution is filtered. The resulting product was a resin solution having a solids content of 80% by weight, a viscosity of 13758 mPa·s and a Hazen color number of 26 APHA.

### Example 5

### Preparation of a Water-Dilutable Polyester Polyol B5)

261 g of propane-1,2-diol, 5506 g of neopentyl glycol, 693 g of trimethylolpropane and 3094 g of maleic anhydride were weighed out together into a 15-liter reactor equipped with stirrer, heating, automatic temperature control, nitrogen inlet, column, water separator and receiver, and were heated to 125° C. with stirring and with nitrogen being passed through. Then 2672 g of adipic acid were added and the mixture was heated to 180° C. at a rate such that the column overhead temperature did not exceed 103° C. During this heating operation the water of reaction was separated off. Condensation was carried out to an acid number of between 4 to 6 mg KOH/g. The batch was then cooled to 140° C. Up to this point in time in the reaction, 1160 g of resin were taken for samples. 1160 g of phthalic anhydride were added to the remaining contents of the reactor and the mixture was stirred at 140° C. until a resin viscosity was reached of 60 to 64 seconds (efflux time from a DIN 4 mm cup at 23° C., 60% solution in methoxypropyl acetate). The resulting product was a clear resin, light in color, with an acid number of 41 mg KOH/g, an OH number of 79 mg KOH/g (based on resin solids), and a viscosity of 62 seconds (efflux time from a DIN 4 mm cup at 23° C., 60% solution in methoxypropyl acetate). 2200 g of butyl glycol were added at 120° C. to 8800 g of this resin and then the batch was stirred at 120° C. for 2 hours. It was then cooled to 60° C. and the resin solution was filtered. The resulting product was a resin solution having a solids content of 79.9% by weight, a viscosity of 8838 mPa·s and a Hazen color number of 25 APHA.

### Example 6

### Preparation of a Blocked Polyisocyanate A1)

352.9 g of Desmodur® Z 4470 MPA/xylene (IPDI trimer, non-blocked, Bayer AG, Leverkusen), 90 g of MPA and 90 g of xylene were introduced as an initial charge under nitrogen and heated to 60° C. 180.2 g of propyl p-hydroxybenzoate were then added to the homogeneous solution in portions with stirring. After the end of addition of the ester, the mixture was stirred at 60° C. until the ester had completely dissolved. Subsequently 1.7 g of DABCO (catalyst) were added and stirring was continued at 60° C. for 19 hours. After this time an NCO content of 0.3% was found by titration. A further 0.6 g of DABCO was added. After 4 hours of stirring at 60° C. free NCO groups were no longer detected by IR spectroscopy. The product was cooled and dispensed. The following properties were determined:

| | |
|---|---|
| Solids content: | 60% |
| Viscosity at 23° C.: | 6000 mPa · s |
| Color: | yellowish |
| Calculated blocked NCO content approx. | 5.8% |

### Preparation of Inventive 1K PU Dispersions, Examples 7 to 15

### Example 7

614.64 g (0.78 eq OH) of the compound from Example 1 and 299.92 g of acetone were heated to 65° C. with stirring and stirred for 30 minutes. To the clear solution were added 149.14 g (0.2106 eq blocked NCO) of the compound from Example 6, followed by stirring at 60° C. for 40 minutes, then of 45.67 g (0.5226 mol) of dimethylethanolamine were added and stirred for 10 minutes. Dispersion was then carried out with 856.76 g of deionized water at room temperature, followed by stirring at 50° C. for 1 hour, cooling to room temperature and freeing from acetone under reduced pressure (1 hour at 120 mbar/40° C.). The batch was then allowed to cool to room temperature with stirring (about 4 hours). The dispersion obtained had the following properties:

| | | |
|---|---|---|
| Solids content: | 45% | |
| pH: | 8.54 | |
| Viscosity at 23° C.: | 46700 | mPa · s |
| Particle size: | 3512 | nm |

### Example 8

622 g (0.5 eq OH) of the compound from Example 2 were dissolved at 65° C. in 284.80 g of acetone with stirring. To the clear solution were added 150.0 g of Desmodur® VP LS 2078 (0.25 eq blocked NCO) (blocked IPDI trimer, Bayer AG, Leverkusen) and the mixture was stirred at 60° C. for 15 minutes. Thereafter 52.25 g (0.585 mol) of dimethylethanolamine were added and the mixture was stirred at 60° C. for 10 minutes and then dispersed with 1554.83 g of deionized water at room temperature. This was followed by stirring at 40° C. for 1 hour, cooling to room temperature and the distillative removal of acetone under reduced pressure (1 hour at 120 mbar/40° C.). The mixture was then allowed to cool with stirring (about 4 hours). The dispersion obtained had the following properties:

| | | |
|---|---|---|
| Solids content: | 30% | |
| pH: | 8.70 | |
| Viscosity at 23° C.: | 14500 | mPa · s |
| Particle size: | 339 | nm |

### Example 9

616.00 g (0.44 eq OH) of the compound from Example 3 were dissolved at 65° C. in 299.52 g of acetone. 132.00 g (0.22 eq blocked NCO) of Desmodur® VP LS 2078 (blocked IPDI trimer, Bayer AG, Leverkusen) were added, followed by stirring at 60° C. for 10 minutes. Thereafter 53.95 g (0.616 mol) of dimethylethanolamine were added and the mixture was stirred at 60° C. for 10 minutes and then dispersed with 1337.81 g of deionized water at room temperature. This was followed by stirring at 50° C. for 1 hour, cooling to room temperature and the distillative removal of acetone under reduced pressure (1 hour at 120 mbar/40° C.). Subsequently the mixture was left to cool with stirring (about 4 hours). The dispersion obtained had the following properties:

| | | |
|---|---|---|
| Solids content: | 35% | |
| pH: | 8.20 | |
| Viscosity at 23° C.: | 8800 | mPa · s |
| Particle size: | 215 | nm |

### Example 10

The procedure described in Example 9 was repeated using 648.12 g of the compound from Example 3 and, instead of Desmodur® VP LS 2078, 157.26 g of the compound from Example 6, 61.76 g (0.69 mol) of dimethylethanolamine and 1609.8 g of deionized water. The dispersion obtained had the following properties:

| | | |
|---|---|---|
| Solids content: | 30% | |
| pH: | 8.05 | |
| Viscosity at 23° C.: | 1500 | mPa · s |
| Particle size: | 282 | nm |

### Example 11

The procedure described in Example 9 was repeated using 547.36 g of the compound from Example 2, 256.69 g of acetone, 157.26 (0.22 eq blocked NCO) of the compound from Example 6, 45.98 g of dimethylethanolamine and 1082.9 g of deionized water. The dispersion obtained had the following properties:

| | | |
|---|---|---|
| Solids content: | 35% | |
| pH: | 8.84 | |
| Viscosity at 23° C.: | 32000 | mPa · s |
| Particle size: | 2900 | nm |

### Example 12

The procedure described in Example 7 was repeated using, instead of the compound from Example 6, 126.36 g (0.2106 eq blocked NCO) of Desmodur® VP LS 2078 (blocked IPDI trimer, Bayer AG, Leverkusen) and 2002.1 g of deionized water. The dispersion obtained had the following properties:

| | | |
|---|---|---|
| Solids content: | 35% | |
| pH: | 8.24 | |
| Viscosity at 23° C.: | 23500 | mPa · s |
| Particle size: | 1698 | nm |

### Example 13

583.12 g (0.74 eq OH) of the compound from Example 1 were dissolved in 280.34 g of acetone. Following the addition of 41.14 g (0.3 eq NCO) of isophorone diisocyanate the mixture was boiled under reflux until NCO groups were no longer detected by IR spectroscopy (about 5 hours). Thereafter 132.24 g (0.185 eq blocked NCO) of the compound from Example 6 were added, followed by stirring for 10 minutes. Thereafter 44.20 g (0.496 mol) of dimethylethanol-amine were added and the mixture was stirred for 10 minutes and then dispersed with 1169.7 g of deionized water at room temperature. Stirring was continued at 50° C. for 1 hour, then the batch was cooled to room temperature and freed from acetone under reduced pressure (finally 1 hour at 120 mbar/40° C.). The dispersion was subsequently cooled to room temperature with stirring (about 4 hours). The dispersion obtained had the following properties:

| | | |
|---|---|---|
| Solids content: | 35% | |
| pH: | 8.45 | |
| Viscosity at 23° C.: | 15000 | mPa · s |
| Particle size: | 3014 | nm |

### Example 14

Added to 795.45 g (1.0 eq) of compound 4 at 23° C. with stirring were 300.00 g (0.5 eq blocked NCO) of Desmodur® VP LS 2078 (blocked IPDI trimer, Bayer AG, Leverkusen) and 53.45 g (0.6 mol) of dimethylethanolamine. The mixture was stirred for 10 minutes and then dispersed with 483.82 g of deionized water at room temperature. This was followed by stirring at 23° C. for 1 hour more. The dispersion obtained had the following properties:

| | | |
|---|---|---|
| Solids content: | 50.7% | |
| pH: | 8.24 | |
| Viscosity at 23° C.: | 4170 | mPa · s |
| Particle size: | 63 | nm |

### Example 15

Added to 708.86 g (1.0 eq) of compound 5 at 23° C. with stirring were 300.00 g (0.5 eq blocked NCO) of Desmodur® VP LS 2078 (blocked IPDI trimer, Bayer AG, Leverkusen) and 43.64 g (0.49 mol) of dimethylethanolamine. The mixture was stirred for 10 minutes and then dispersed with 527.54 g of deionized water at room temperature. This was followed by stirring at 23° C. for 1 hour more. The dispersion obtained had the following properties:

| | | |
|---|---|---|
| Solids content: | 48.6% | |
| pH: | 7.42 | |
| Viscosity at 23° C.: | 3700 | mPa · s |
| Particle size: | 133 | nm |

### Example 16

### Preparation of a Blocked Polyisocyanate A2)

315 g of Desmodur® N 3300 (HDI trimer, non-blocked, Bayer AG, Leverkusen) were introduced as an initial charge under nitrogen and heated to 60° C. 187 g of ε-caprolactam were then added to the polyisocyanate in portions with stirring. After the end of the addition, the mixture was stirred at 60° C. until the 6-caprolactam had completely dissolved. The batch was subsequently heated to 80° C. and stirred at 80° C. until free NCO groups were no longer detected by IR spectroscopy. Thereafter 125 g of Solvent Naphtha 100 solvent were added and dissolution was carried out with stirring. The product was cooled and dispensed. The following properties were determined:

| | |
|---|---|
| Solids content: | 80% |
| Viscosity at 23° C.: | 17520 mPa · s |
| Color: | colorless |
| Calculated blocked NCO content approx. | 12.4% |

### Use Examples

Clear coating compositions were prepared by intimately mixing the following ingredients at room temperature. Examples 17 to 21 are inventive 1K PU dispersions, while Example 22 is a comparison dispersion based on a commercially available epoxy resin.

| | Example | Example | Example | Example | Example | Comparison |
|---|---|---|---|---|---|---|
| Formulation | 17 | 18 | 19 | 20 | 21 | Example 22 |
| Polyester Example 5 | 38.8 g | | | | | |
| Polyester Example 4 | | 38.8 g | | | | |
| Polyester Example 1 | | | 46.6 g | | | |
| Polyester Example 3 | | | | 46.6 g | | |
| Product from Example 15 | | | | | 84.2 g | |
| Desmodur ® VP LS 2078¹⁾ | 14.6 g | | | | | |
| Blocked polyisocyanate Example 6 | | 14.6 g | | | | |
| Blocked polyisocyanate Example 16 | | | 11.5 g | 11.5 g | | |
| Butyl glycol | 11.5 g | 11.5 g | 8.8 g | 8.8 g | | |
| Water/butyl glycol 85:15 | | | | | 15.8 g | |
| N,N-dimethylethanolamine, 10% in water | 35.1 g | 35.1 g | 33.1 g | 33.1 g | | |
| Formaldehyde/phenol resin²⁾ | | | | | | 13.8 g |
| Epikote ® 1007³⁾ | | | | | | 82.9 g |
| Phosphoric acid, 10% in n-butanol | | | | | | 3.3 g |

¹⁾blocked aliphatic polyisocyanate (IPDI) from Bayer MaterialScience AG, Leverkusen, DE
²⁾Resistherm LVP BBB 2036, Bayer MaterialScience AG, Leverkusen, DE
³⁾epoxy resin from Resolution Europe BV, 3190 AN Hoogvliet Rt, NL

The clear coating compositions were applied to tinplate sheets E1 (Rasselstein Hoesch, Andemach, DE) using a commercially available coating bar from Deka and were baked in a forced-air oven at 180° C. for 10 minutes. This resulted in dry film thicknesses of approximately 8-10 μm.

Test Results:

The following coatings properties were found:

| | Example | | | | | |
|---|---|---|---|---|---|---|
| | 17 | 18 | 19 | 20 | 21 | C22 |
| Cross-cut adhesion^{a)} | 0 | 0 | 0 | 0 | 0 | 0 |
| Flexural impact test^{b)} (mm torn) | 20 | 20 | 30-40 | 20-30 | 20 | 20-30 |
| Deep drawing/circular cups^{c)} | 0 | 0 | 0 | 0 | 0 | 0 |
| Stack resistance^{d)} | 1 | 1 | 1 | 1 | 1 | 1 |
| MEK wipe test^{e)} | 45-50× | 35-40× | 40-45× | 50-55× | 45-50× | 80×(soft) |
| Sterilisation^{f)} | 0 | 1 | 1 | 0 | 0 | 0 |

^{a)}Cross-cut adhesion (to DIN 53151) evaluation: 0 = good, 5 = poor.
^{b)}Erichsen impact fold tester Type 471 (test machine (Erichsen GmbH & Co KG, Hemer, DE), impact hammer 2300 g, drop height 650 mm, tear length reported in mm).
^{c)}Erichsen deep-draw cup test machine (Erichsen GmbH & Co KG, Hemer, DE), evaluation in accordance with DIN 53230.
^{d)}Pairs of coated sheets were stacked with the coated sides against one another. A black band filter was placed between the coated sheets. The stack was subsequently loaded with a steel plate for improved weight distribution and with a 5 kg weight and was stored at 50° C. for 16 h. Following storage, any damage to the film (such as impression traces of the filter paper) were scored visually; evaluation: 0 = good, 5 = poor.
^{e)}A cotton wad soaked with methyl ethyl ketone (MEK) was moved back and forth over the coating film 100 times with a constant pressure (100 double rubs). If severe damage or delamination was observed even after less than 100 double rubs, the test was discontinued. After the test the sheets were assessed visually for clouding and/or film delamination.
^{f)}Cured coatings were treated in a sterilizer (Aesculap JA 154, Aesculap AG, Tuttlingen, DE), for 2 h at 1.2 bar/121° C., after which the coating was investigated for loss of adhesion (stripping), loss of gloss, water spots and blistering; evaluation: 0 = good, 5 = poor

Discussion of Results:

All varnishes tested have very good adhesion to tinplate and exhibit good elasticity. The stack resistance and the resistance properties of the varnishes are of a comparably high quality, with the comparison coating C22 showing a somewhat better MEK resistance. The particular advantage associated with coatings V17 to V21 of the invention, however, is that they are completely free from bisphenol A diglycidyl ether (BADGE), since they are not based on epoxy resins as raw materials. The blocking agent used in the crosslinkers was not detected in the coatings by analysis.

The sheets coated in accordance with the invention were stored for 2 h at 121° C. in 120 ml of a mixture of equal volumes of ethanol and water. The liquid was subsequently analyzed by chromatography for blocking agent released. With a detection limit of 3 μg/l, no released blocking agent was found.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An aqueous coating composition comprising
A) at least one polyisocyanate which contains an average of at least two NCO groups per molecule and in which at least 85% of the NCO groups are blocked with a blocking agent comprising a member selected from ε-caprolactam, p-hydroxycarboxylic acids and aliphatic alcohol and
B) at least one hydrophilic polyester polyol containing an average of at least two reactive hydroxyl groups per molecule, or mixture of a hydrophilic and a non-hydrophilic polyester polyol, wherein component B) has an acid number of ≧15 mg KOH/g, a hydroxyl number of 20 to 300 mg KOH/g and a weight average molecular weight, M_{w}, of >1500 g/mol,
wherein the equivalent ratio between the blocked isocyanate groups of component A) and the isocyanate-reactive groups of component B) is 0.5 to 5.0:1.

2. The aqueous coating composition of claim 1 wherein component A) comprises
i) 100 equivalent % of a polyisocyanate,
ii) a total of 60 to 100 equivalent % of ε-caprolactam and/or a hydroxybenzoic acid derivative of formula (I) 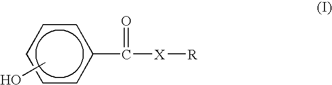
wherein
x is oxygen, NH or NR and
R is hydrogen, a C₁ to C₈ alkyl radical or cycloalkyl radical, and
iii) 0-40 equivalent % of an at least difunctional compound containing hydroxyl and/or amino groups and having a number average molecular weight of 32 to 3000,
wherein the proportions of the reactants are chosen such that the equivalent ratio of NCO groups of component i) to the isocyanate-reactive groups of components ii) and iii) is 1:0.8 to 1:1.2.

3. The aqueous coating composition of claim 1 wherein polyester polyol B) comprises the reaction product of
a) 40 to 49 mole % of a carboxylic acid component comprising
a1) one or more aliphatic, cycloaliphatic, araliphatic and/or aromatic carboxylic acids having a COOH functionality ≧2, or an anhydride thereof and
a2) optionally an aromatic, cycloaliphatic and/or aliphatic monocarboxylic acid with
b) 51 to 60 mole % of an alcohol component comprising
b1) one or more aliphatic, cycloaliphatic and/or araliphatic polyols with a number-average molecular weight of 62 to 272 g/mol and an average OH functionality ≧2, and
b2) optionally an aliphatic, cycloaliphatic and/or araliphatic monoalcohol,
c) optionally water,
d) neutralizing agents, and
e) optionally solvents and additives.

4. The aqueous coating composition of claim 1 wherein component B) has an acid number of 20 to 75 mg KOH/g solid resin.

5. A process for preparing the aqueous coating composition of claim 1 which comprises mixing components A) and B) below the temperature at which the blocked NCO groups of component A) can react with component B) and subsequently adding water and dispersing.

6. The process of claim 5 which comprises mixing component A) which has not been rendered hydrophilic or has been rendered hydrophilic only to a small extent, with component B), prior to the addition of water, and then dispersing the mixture of components A) and B).

7. A substrate coated with the aqueous coating composition of claim 1.

8. The substrate of claim 7 wherein the substrate is a metallic substrate.

9. The substrate of claim 7 wherein the substrate is packaging or the interior of a can.

10. The substrate of claim 7 wherein the substrate is the interior of can suitable for use for foodstuffs.
